(19) United States
(12) Patent Application Publication
(10) Pub. No.: US 2017/0286356 A1
(43) Pub. Date: Oct. 5, 2017

(54) ENHANCED QUALITY OF SERVICE MECHANISM FOR MA USB PROTOCOL

(71) Applicant: Intel Corporation, Santa Clara, CA (US)

(72) Inventors: ELAD LEVY, Nes Ziona (IL); Michael Glik, Kfar Saba (IL); Bahareh Sadeghi, Portland, OR (US); Daniel Cohn, Raanana (IL); Rafal Wielicki, Gdansk (PL)

(21) Appl. No.: 15/088,622

(22) Filed: Apr. 1, 2016

(51) Int. Cl. G06F 13/42; G06F 13/38

(52) U.S. Cl. CPC G06F 13/4286; G06F 13/385

(57) ABSTRACT

The disclosure generally relates to methods, system and apparatus to optimize Quality of Service (QoS) for communications using Medium Agnostic Universal Serial Bus (MA USB) protocol. In one embodiment, assignment of specific QoS parameters for certain Endpoint is triggered by the platform running MA USB host once a specific usage model occurs. Once triggered, MA USB Host engages an MA USB Hub or Device in a two-way handshake to communicate QoS parameters. The two-way handshake includes transmitting an Update Endpoint Quality-of-Service (QoS) Request frame to the selected Endpoint Handles at the MA USB Device; and receiving an Update Endpoint QoS Response from the MA USB Device.

### BACKGROUND

### Field

The disclosure generally relates to a method, system and apparatus to optimize communications using Medium Agnostic Universal Serial Bus (MA USB). Specifically, the specification relates to methods, system and apparatus to communicate Quality-of-Service (QoS) parameters for specifically-selected device endpoint(s) within a specific data transfer type.

### Description of Related Art

MA USB enables transport of USB traffic over media other than USB cable, including wireless connections. Satisfying the Quality of Service (QoS) requirements of USB Endpoint (EP) over the dynamic wireless channel where limited resource can be shared by multiple users is a challenge. The current MA USB Standard (Release 1.0a, Jul. 29, 2015), which is incorporated herein in its entirety for background information, defines several logical channels for delivering MA USB packets. The packets include a packet for management traffic and one or more packets for Data and Control. Data packets are divided into several Transfer Types including, Control, Bulk, Interrupt and Isochronous packets. Management packets, Control packets and Data packets from different Transfer Types can be identified by the MA USB packet header which provides the necessary information within Type and T-flag fields. The headers provide a mechanism for implementing different QoS handling for each packet.

However, the existing solutions do not differentiate among data packets belonging to the same Transfer Type (e.g., Bulk packet type). An example of scenarios that requires different QoS for different Data packets handling common within the Bulk Transfer type is prioritizing outgoing Bulk data packets belonging to display traffic over other Bulk traffic (e.g., mass storage or Network access). Another example is prioritizing incoming Bulk data packets belonging to camera streaming traffic over other Bulk traffic (e.g., mass storage or Network access).

With MA USB protocol targeting operation over media with limited Bandwidth and increased Latency (compared to the wired USB medium) such differentiation is required for preventing starvation of higher priority traffic by lower priority traffic belonging to the same Transfer Type.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 is a system diagram for a conventional MA USB service set;

FIG. 2 illustrates an exemplary handshake to set QoS at an Endpoint;

FIG. 3 schematically illustrates an exemplary payload packet for an EP QoS Request according to one embodiment of the disclosure;

FIG. 4 shows a flow-diagram for an exemplary implementation of an embodiment of the disclosure;

FIG. 5 shows an exemplary MA USB Host architecture for implementing an embodiment of the disclosure; and

FIG. 6 shows an exemplary MA USB device architecture for implementing an embodiment of the disclosure.

### DETAILED DESCRIPTION

Certain embodiments may be used in conjunction with various devices and systems, for example, a mobile phone, a smartphone, a laptop computer, a sensor device, a Bluetooth (BT) device, an Ultrabook™, a notebook computer, a tablet computer, a handheld device, a Personal Digital Assistant (PDA) device, a handheld PDA device, an on board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (AV) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing Institute of Electrical and Electronics Engineers (IEEE) standards (IEEE 802.11-2012, IEEE Standard for Information technology-Telecommunications and information exchange between systems Local and metropolitan area networks—Specific requirements Part 11: Wireless LAN Medium Access Control (MAC) and Physical Layer (PHY) Specifications, Mar. 29, 2012; IEEE 802.11 task group ac (TGac) (“IEEE 802.11-09/0308r12-TGac Channel Model Addendum Document”); IEEE 802.11 task group ad (TGad) (IEEE 802.11ad-2012, IEEE Standard for Information Technology and brought to market under the WiGig brand-Telecommunications and Information Exchange Between Systems-Local and Metropolitan Area Networks-Specific Requirements-Part 11: Wireless LAN Medium Access Control (MAC) and Physical Layer (PHY) Specifications-Amendment 3: Enhancements for Very High Throughput in the 60 GHz Band, 28 Dec. 2012)) and/or future versions and/or derivatives thereof, devices and/or networks operating in accordance with existing Wireless Fidelity (Wi-Fi) Alliance (WFA) Peer-to-Peer (P2P) specifications (Wi-Fi P2P technical specification, version 1.2, 2012) and/or future versions and/or derivatives thereof, devices and/or networks operating in accordance with existing cellular specifications and/or protocols, e.g., 3rd Generation Partnership Project (3GPP), 3GPP Long Term Evolution (LTE), and/or future versions and/or derivatives thereof, devices and/or networks operating in accordance with existing Wireless HD™ specifications and/or future versions and/or derivatives thereof, units and/or devices which are part of the above networks, and the like.

Some embodiments may be implemented in conjunction with the BT and/or Bluetooth low energy (BLE) standard. As briefly discussed, BT and BLE are wireless technology standard for exchanging data over short distances using short-wavelength UHF radio waves in the industrial, scientific and medical (ISM) radio bands (i.e., bands from 2400-2483.5 MHz). BT connects fixed and mobile devices by building personal area networks (PANs). Bluetooth uses frequency-hopping spread spectrum. The transmitted data are divided into packets and each packet is transmitted on one of the 79 designated BT channels. Each channel has a bandwidth of 1 MHz. A recently developed BT implementation, Bluetooth 4.0, uses 2 MHz spacing which allows for 40 channels.

Some embodiments may be used in conjunction with one way and/or two-way radio communication systems, a BT device, a BLE device, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like. Some demonstrative embodiments may be used in conjunction with a WLAN. Other embodiments may be used in conjunction with any other suitable wireless communication network, for example, a wireless area network, a “piconet”, a WPAN, a WVAN and the like.

Various embodiments of the invention may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

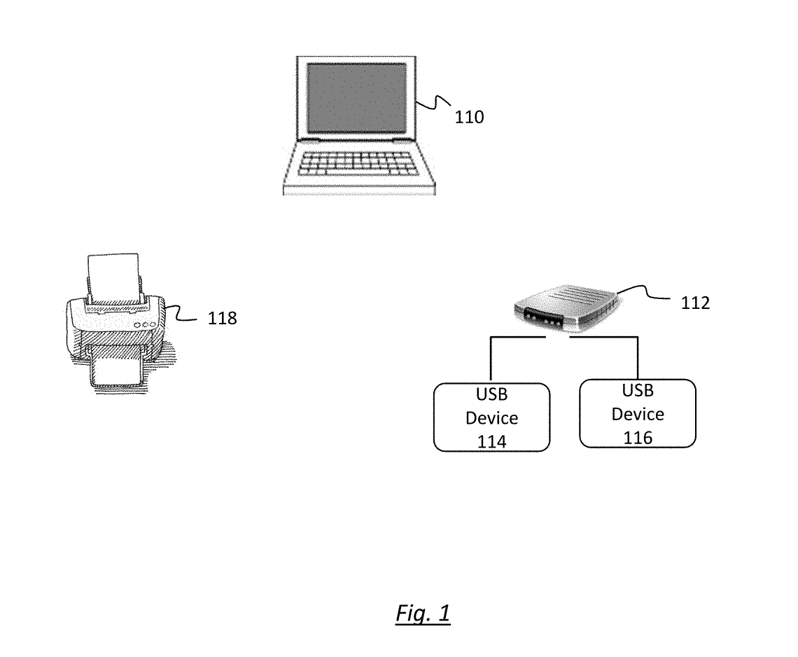

FIG. 1 is a system diagram for a conventional MA USB service set. The service set of FIG. 1 includes MA USB Host 110, MA USB Hub 112 and MA USB device 118. MA USB Hub 112 is wired to USB Devices 114 and 116. MA USB Host 110 communicates wirelessly with each of MA USB Device 118 and MA USB Hub 112. MA USB Host 110 communicates with MA USB Devices 116 and 114. From the host system perspective, each MA USB host instance introduces a separate virtual bus.

Pursuant to the current MA USB Standard (Media Agnostic Universal Serial Bus Specification, Release 1.0a, Jul. 29, 2015, which is incorporated herein in its entirety for background information), an MA USB Hub 112 is a device that integrates either a USB 2.0 hub or a USB 3.1 hub and provides physical downstream facing USB ports to attach removable or non-removable USB devices. An MA USB hub performs all USB hub functions for control and management of its downstream facing USB ports. The MA USB Host 110 is an architectural element of the MA USB PAL that includes a physical link interface and USB host logic as defined in USB Specifications. An MA USB host Physical Adaptation Layer (PAL), as defined in the current specification, manages the MA USB devices and transport of USB payload over the MA link.

The MA USB Host 110 and MA USB Devices (114 and 116) discover one another using device discovery mechanism provided by the lower layers of the MA USB protocol. The discovery mechanism includes exchanging over the air MA USB management packets related to USB device enumeration. During the enumeration process the device and its respective endpoints are identified. For example, responsive to a USB port connect event, the USB host core system software creates a new context (device object) for the device that is connected downstream of the port. The device object will be populated with information extracted from the device (descriptors etc.) and is typically used by the host system to store the state of the device. When the USB Client device driver issues a SetConfiguration request to USB system software, the USB host core system software will create a new endpoint context (an endpoint object) for each endpoint in the configuration referenced by the SetConfiguration request. The endpoint object can be used by the host system software to store the state of the endpoint. There are situations where additional device parameters are determined by policies of the host system software or are obtained in the later phases of enumeration. This event represents the projection of host system policies that need to be recorded in the device object for proper operation on the bus. Before, a device can be used, it must be explicitly configured. In typical USB host systems, the client device driver requests USB system software to set a specific configuration on the device. The USB host system software will allocate endpoint objects for the endpoints described in the selected configuration and will issue a SetConfiguration request to the device. Integrated USB device enumeration follows successful establishment of MA USB device connection with the MA USB host. Following the MA USB session establishment, the MA USB host PAL emulates a port status change event equivalent of connecting a wired USB device to one of the root ports, which will trigger port manipulation actions by the MA USB host USB core system. These actions are handled locally by the MA USB host PAL.

The MA USB communication model assumes a logical separation of management (i.e., control) and non-management (i.e., data) packets. All management packets are assumed to be exchanged over a single (logical) management channel while all control and data packets are assumed to be exchanged over one or more (logical) data channels. All channels are bidirectional. While the physical realization of management and data channels is implementation specific, channels are expected to meet specific timings on top of which protocol operation details such as timeouts are defined.

In order to establish the WSB service, a wireless service advertiser and a wireless service seeker perform service discovery, peer-to-peer (P2P) connection setup, and Wireless Serial Bus (WSB) session setup. Once the WSB service is established, the MA USB protocol may be deployed either over an Internet Protocol (IP) stack or directly over a Media Access Control (MAC) layer to transport data for the WSB session over the P2P wireless connection.

The current MA USB standard does not provide an interoperability solution for prioritizing traffic within the same transfer type or endpoint. An embodiment of the disclosure provides an interoperable solution which may operate among different vendors. The interoperability substantially guarantees an end-to-end QoS to applications with strict bandwidth/latency requirements (e.g., video).

In one embodiment of the disclosure, assignment of specific QoS parameters for certain Endpoints can be triggered by the platform running MA USB Host once a specific usage model occurs. The triggers may be related to specific enumerated USB device (identified by its descriptors) or to a specific link condition observed by the underlying transport (e.g., limited BW or increased latency) or to a combination of both. Other factors may be considered relevant in triggering the assignment of specific QoS parameters. The triggering event may occur after the initial enumeration has occurred.

Once triggered, the MA USB Host may execute a two-way handshake with the MA USB device associated with the relevant endpoint. The handshake can be used to communicate the desired QoS attributes for the identified Endpoint. It should be noted that the handshake is exemplary and other methods of communicating the desired QoS may be implemented without departing from the disclosed embodiments.

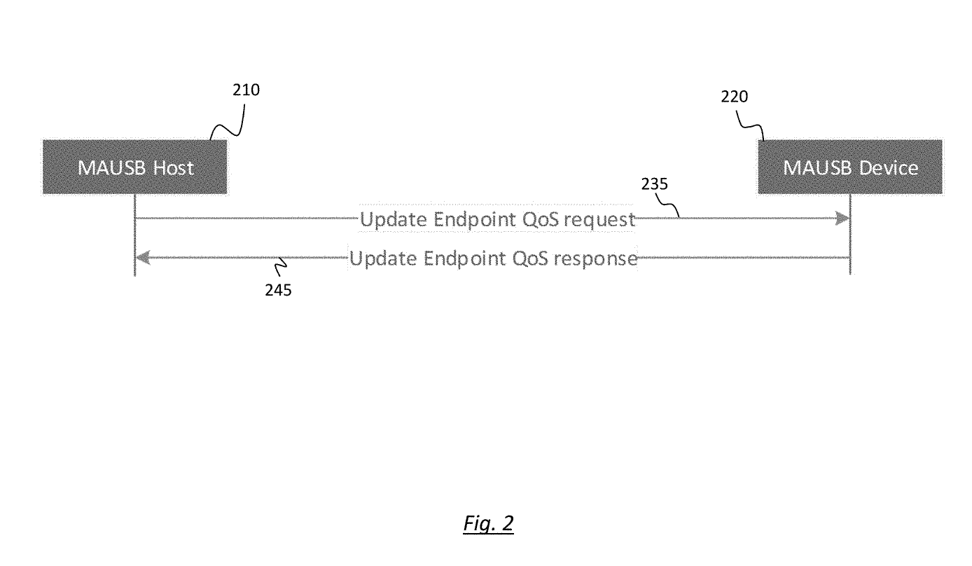

FIG. 2 illustrates an exemplary handshake to set QoS at an Endpoint. Here, MA USB Host 210 communicates with MA USB Device 220. MA USB Device may include an MA USB device or an MA USB Hub. In an exemplary embodiment, the MA USB device may be replaced with MA USB hub (not include one). MA USB hub is a private case of MA USB device. The communication may be initiated after one or more Endpoints have been enumerated at MA USB Host 220 and after a QoS determination has been made at the MA USB host 210. In an exemplary embodiment, MA USB Host 210 may initiate the message exchange for a certain Endpoint any time after assigning EndpointHandle. Under the MA USB Standard, an Endpoint handle request packet may be sent from Host 210 to MA USB Device 220 to establish the endpoint. Next, an Update Endpoint QoS Request 235 can be sent form MA USB Host 210 to MA USB device 220. MA USB Device 220 can respond by sending Update Endpoint QoS Response 245 to MA USB Host 2210. This enables dynamic update of QoS parameters to be established to accommodate a current message delivery at the MA USB host platform. For example, MA USB Host 210 may determine that Endpoint n (not shown) at MA USB Device 220 is receiving video data. Accordingly, bulk data directed to Endpoint n of MA USB Device 220 may be given higher communication priority as compared with other bulk data destined for MA USB Device 220.

An exemplary Endpoint QoS Request frame may carry one or more of the following parameters: Transfer type, Endpoint Handle list, Priority and QoS Parameters. The transfer type parameter identifies the transfer type of the Endpoint(s) for which the QoS parameters are requested to be updated. The Endpoint Handle list identifies the list of Endpoints on the MA USB device pertaining to the request (all Endpoints may have the same transfer type). The Priority parameter identifies the priority of the traffic belonging to the Endpoint Handle list compared to the traffic belonging to other endpoints. The Priority parameter may be set in a strict or relative manner. A strict priority is described in an absolute order. A non-strict priority serves as a guideline. In one embodiment, Endpoints may also be de-prioritized by indicating negative priority. QoS parameters quantify the e2e QoS parameters that the packets belonging to the list of Endpoints should encounter. The QoS parameters may include latency, throughput and the like.

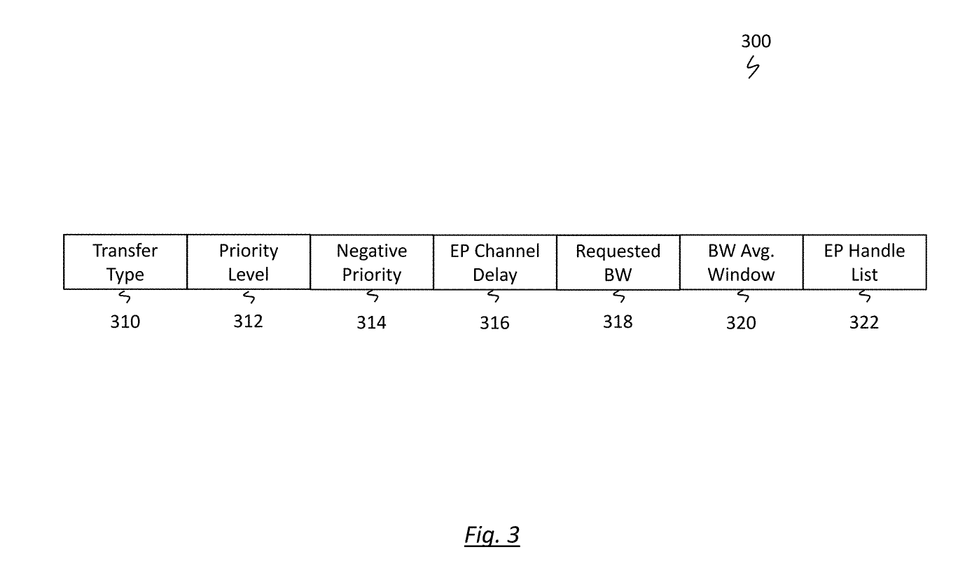

In another exemplary embodiment, the payload may be expanded to include additional information and parameters. FIG. 3 schematically illustrates an exemplary payload packet 300 for an EP QoS Request according to one embodiment of the disclosure. The content of payload 300 of FIG. 3 is described below at TABLE 1 which provides definition for the payload carried by an Update Endpoint QoS Request.

TABLE 1

| Width | Offset | |
|---|---|---|
| (bits) | (DW:bit) | Description |
| 8 | 3:0 | Transfer type (310) - 0 Control, 1 Isochronous, 2 Bulk, 3 |
| | | Interrupt |
| 7 | 3:8 | Priority level (312) - for implementations utilizing strict |
| | | priority this parameter set the priority order. For non-strict |
| | | priority implementations this value will serve as prioritization |
| | | guideline. |
| | | The value of 0 is the default priority level per Transfer Type. |
| | | Any value greater than 0 indicates the specified Endpoints |
| | | should be prioritized over other traffic on the same Transfer |
| | | Type (from Endpoints which were not indicated in any Update |
| | | Endpoint QoS req). |
| 1 | 3:15 | Negative priority (314) - flag indicating the priority level |
| | | assigned above is negative i.e. the Endpoints specified in this |
| | | message should be de-prioritized compared to the default |
| | | priority of the specified Transfer Type. |
| | | E.g. negative priority 2 has lower priority from negative |
| | | priority 1. |
| 16 | 3:16 | EndpointChannelDelay (316) - optional parameter (ignored |
| | | if 0). |
| | | Indicates the max one way delay that a data packet belonging |
| | | to one of the Endpoints below should encounter between the |
| | | sending PAL to the receiving PAL. |
| 32 | 4:0 | Requested Bandwidth (318) - optional parameter (ignored if |
| | | 0). |
| | | Indicates the bandwidth requested for all the Endpoints |
| | | specified below. MA USB device receiving this request can |
| | | utilize this parameter for reserving the requested BW, limiting |
| | | the BW consumed by the Endpoints below to this value or |
| | | both. |
| 32 | 5:0 | Bandwidth Averaging window (320) - optional parameter |
| | | (ignored if 0 or if Requested BW is 0). |
| | | Indicates the time window for averaging the BW consumed by |
| | | the Endpoints specified below. |
| Variable | 6:0 | EP Handle List (322) - List of EP handles the MA USB host |
| | | is referencing in this request, concatenated in 16-bit |
| | | increments. All Endpoints specified within a single message |
| | | shall belong to the same Transfer Type. |

An exemplary MA USB Host may cancel the QoS request at any time by sending a Update Endpoint QoS request setting priority to the default priority (e.g., priority level=0 in example of TABLE 1) for the same list of Endpoint handles. Deleting an EP (using EpDeleteReq) or events that return an EP to its initial state may also cancel any QoS settings for a certain EP. A newly established EP (using EpHandleReq) may be assigned with the default QoS values.

An exemplary Update Endpoint QoS Response frame carries the status of establishing the desired QoS settings in the MA USB device side. Failure of assigning the QoS settings to any of the desired Endpoints may be reported with appropriate status code. In another exemplary implementation, the Update Endpoint QoS Response frame may carry no payload or it may carry the value of QoS parameters as experienced by the identified traffic.

The method of managing the QoS settings at the underlying transport layer may be specific to the underlying medium and may be implementation-specific or specified for each different medium. MA USB host may decide to activate those QoS settings regardless of whether MA USB device reports a failure in its Update Endpoint QoS Response frame or reports a successful completion of the request.

Whether an MA USB device supports priority setting for different Endpoints/transfer types can be reported to the MA USB Host during enumeration of the MA USB device by the Host. In one implementation, this can be done as part of the capabilities supported by the MA USB device (in Capability Response packet). If a device does not support this feature it may be indicated in the capability response packet sent to the MA USB Host. As part of the support of the capability the MA USB device can also indicate the granularity for the priority or specific QoS parameters that are supported. In one embodiment, the MA USB Host may not request assignment of QoS parameters beyond the declared capability of the MA USB Device. MA USB device receiving such request shall reject it using Update Endpoint QoS Response frame with Status=ERROR_INVALID_REQUEST.

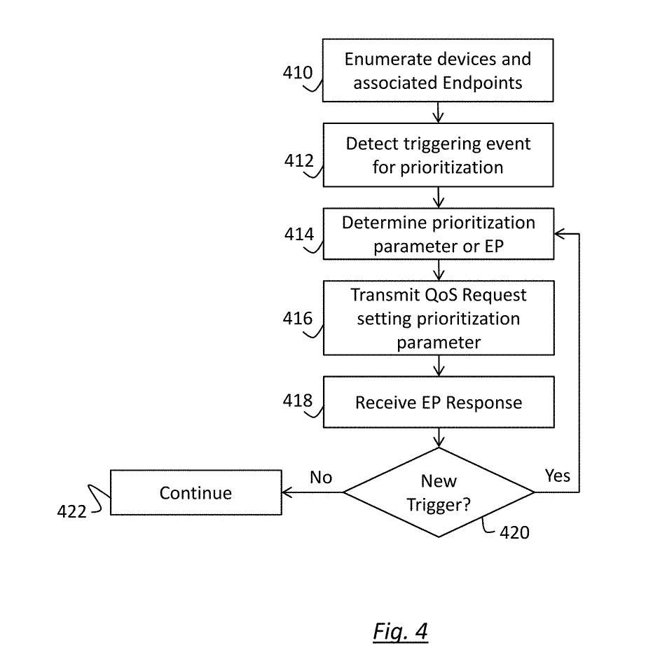

FIG. 4 shows a flow-diagram for an exemplary implementation of an embodiment of the disclosure. The flow-diagram of FIG. 4 may be implemented at an actual or a virtual processor or a combination thereof. In an exemplary embodiment, the flow-diagram of FIG. 4 may be implemented entirely in a software module associated with a MA USB. In another exemplary embodiment, the flow-diagram of FIG. 4 may be implemented as a driver installed on the MA USB Host processor. The flow-diagram of FIG. 4 starts at step 410 where the MA USB device enumerates the Endpoints associated with MA USB devices. At step 412, MA USB detects a triggering event. The Endpoint may be associated with an MA USB Hub or an MA USB device. The triggering event may be, for example, detection of data packets directed at a discovered Endpoint which must be handled expeditiously relative to other similar data packet types (e.g., bulk video data). In one embodiment, the triggering event may be determined according to the function of the first Endpoint or by a communication link condition with the MA USB device or a combination thereof.

At step 414, the MA USB Host may determine the prioritization level for packet delivery to the identified Endpoint. The prioritization may increase expediency with which data packets are delivered to the MA USB Device. In another embodiment, prioritization may comprise setting the delivery priority back to the MA USB default level. In yet another embodiment, prioritization may include deprioritizing packet delivery speed (i.e., reducing priority below the default priority rate.)

At step 416, the MA USB Host may transmit QoS Request setting prioritization parameter to the identified Endpoint. The QoS Request may be one or more data frames setting the prioritization parameters for handling data packets for the identified Endpoint. For example, the data frame may include an Update Endpoint QoS Request having one or more of transfer type, first Endpoint Handle list, Priority and QoS parameters. At step 418, the MA USB Host may receive an Update Endpoint QoS Response from MA USB Device.

At step 420, a determination is made whether a new trigger is detected. That is, a decision can be made as to whether to continue the prioritization rate. If a new triggering event is detected, then the process returns to step 414. The triggering event may necessitate increasing, decreasing, or setting the prioritization rate back to the default rate. Thus, the MA USB Host can dynamically update the prioritization parameter by sending a subsequent Update Endpoint Quality-of-Service (QoS) Request frame to the first Endpoint at the MA USB Device.

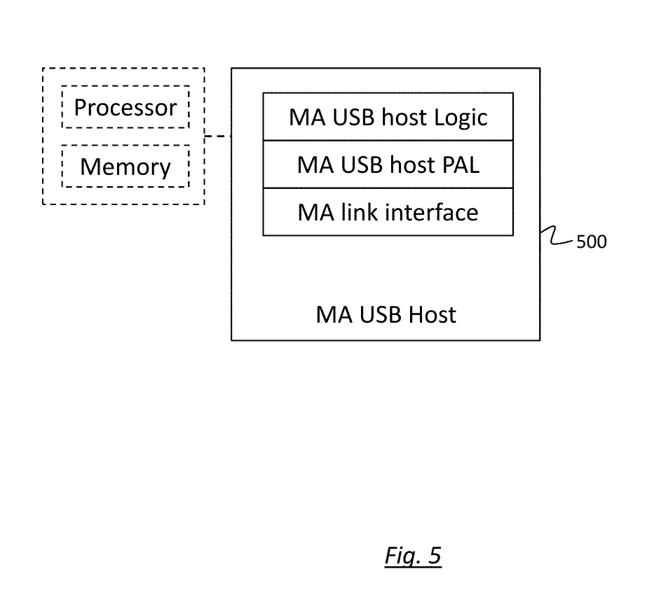

FIG. 5 shows an exemplary MA USB Host architecture for implementing an embodiment of the disclosure. The architecture may be optionally stored at a memory circuitry in communication with an optional processor circuitry to implement the MA USB host logic. FIG. 5 shows MA USB host 500 having USB host logic layer, MA USB host Protocol Adaptation Layer and MA link interface layer. The MA USB host 500 building blocks may integrate into existing USB infrastructure. The MA USB host provides the same abstraction of the USB bus that the USB driver in an Operating System provides. It may additional provide prioritization functionality disclose herein. Thus, conventional software drivers for various USB classes (e.g., storage, human interface devices (HID), audio and video devices, etc.) can run along with the disclosed embodiments over the USB protocol without any changes to the underlying device or protocol. The data frame and packet management disclosed herein may be implemented on one or both of the MA link interface and MA USB host PAL. The MA USB host PAL manages the transport of payload over the MA link interface. All communications between MA USB Host and Devices (or peers) are strictly PAL-to-PAL.

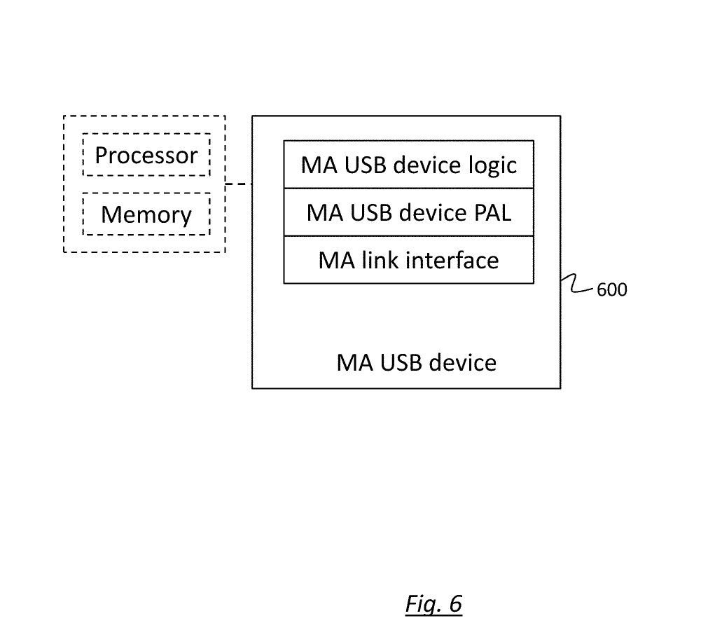

FIG. 6 shows an exemplary MA USB device architecture for implementing an embodiment of the disclosure. MA USB device is the counterpart to the MA USB host for enabling remote connectivity to peripheral devices. The MA USB device performs all USB transfers over MA link interface according to the frame format and rules of the MA link. These rules may include prioritized packet handling as disclosed herein. The MA USB device architecture may be optionally stored at a memory circuitry in communication with an optional processor circuitry to implement the MA USB host logic. The MA USB device may include hardware, software or a combination of hardware and software. MA USB device 600 may complement existing USB or MA USB infrastructure in a peripheral device. The device-side class drivers can run over the MA USB protocol layer with no change. The MA USB device 600 includes MA USB device logic, MA USB device PAL and MA link interface.

The following examples are provided to illustrate additional exemplary and not non-limiting embodiments of the disclosure. Example 1 is directed to a method to communicate one or more Quality-of-Service (QoS) parameters between a Medium Agnostic Universal Serial Bus (MA USB) Host and an MA USB device having one or more Endpoints, the method comprising: determining one or more parameters to be communicated to an identified Endpoint; executing a two-way handshake with the MA USB device to communicate the one or more QoS Parameters, wherein the two-way handshake further comprises: transmitting an Update Endpoint Quality-of-Service (QoS) Request frame to the first Endpoint at the MA USB Device; and receiving an Update Endpoint QoS Response from the MA USB Device.

Example 2 is directed to the method of example 1, wherein the Update Endpoint QoS Request further comprises a data frame having one or more of transfer type, Endpoint Handle list, Priority and QoS parameters.

Example 3 is directed to the method of any preceding example, wherein the QoS parameters quantifies the end-to-end QoS parameters that the packets belonging to the identified Endpoint encounters.

Example 4 is directed to the method of any preceding example, further comprising, dynamically updating the prioritization parameter by sending a subsequent Update Endpoint Quality-of-Service (QoS) Request frame to the first Endpoint at the MA USB Device.

Example 5 is directed to the method of any preceding example, wherein the device further comprises an MA USB Hub or a MA USB portable device configurable to execute the two-way handshake.

Example 6 is directed to the method of any preceding example, wherein the Update Endpoint Quality-of-Service (QoS) Request frame comprises a payload identifying: transfer type, priority level, negative priority, Endpoint Channel Delay, Requested Bandwidth, Bandwidth Averaging Window and EP Handle List.

Example 7 is directed to a Medium Agnostic Universal Serial Bus (MA USB) Host comprising a Physical Adaptation Layer (PAL) and a Media-Access Control (MAC) Layer to provide prioritized data transmission to a one of plurality of Endpoints within in an MA USB device, wherein the HUB includes processing logic executable on a the PAL or the MAC layer to: determine one or more QoS parameters to be communicated to an identified Endpoint; execute a two-way handshake with the MA USB device to communicate the one or more QoS Parameters, wherein the two-way handshake further comprises: transmitting an Update Endpoint Quality-of-Service (QoS) Request frame to the first Endpoint at the MA USB Device; and receiving an Update Endpoint QoS Response from the MA USB Device.

Example 8 is directed to the MA USB Host of example 7, wherein the Update Endpoint QoS Request further comprises a data frame having one or more of transfer type, Endpoint Handle list, Priority and QoS parameters.

Example 9 is directed to the MA USB Host of any preceding example, wherein the QoS parameters quantifies the end-to-end QoS parameters that the packets belonging to the identified Endpoint encounters.

Example 10 is directed to the MA USB Host of any preceding example, wherein the processing logic further comprises dynamically updating the prioritization parameter by sending a subsequent Update Endpoint Quality-of-Service (QoS) Request frame to the first Endpoint at the MA USB Device.

Example 11 is directed to the MA USB Host of any preceding example, wherein the Update Endpoint QoS Response is received from an MA USB Hub or a MA USB portable device configured to execute the two-way handshake.

Example 12 is directed to the MA USB Host of any preceding example, wherein the Update Endpoint Quality-of-Service (QoS) Request frame comprises a payload identifying: transfer type, priority level, negative priority, Endpoint Channel Delay, Requested Bandwidth, Bandwidth Averaging Window and EP Handle List.

Example 13 is directed to a Medium Agnostic Universal Serial Bus (MA USB) Hub comprising a Physical Adaptation Layer (PAL) and a Media-Access Control (MAC) Layer to receive data transmission to one of plurality of Endpoints associated therewith, wherein the Hub includes processing logic executable on the PAL or the MAC layer to: receive an Update Endpoint Quality-of-Service (QoS) Request frame from an MA USB Host, wherein the Update Endpoint Quality-of-Service (QoS) Request frame is directed to an identified Endpoint associated with the MA USB Hub; and transmit an Update Endpoint QoS Response to the MA USB Hub.

Example 14 is directed to the MA USB Hub of any preceding example, wherein the processing logic includes verifying the Update Endpoint Quality-of-Service (QoS) Request frame before transmitting an Update Endpoint QoS Response to the MA USB Hub.

Example 15 is directed to the MA USB Hub of any preceding example, wherein the Update Endpoint QoS Request further comprises a data frame having one or more of transfer type, Endpoint Handle list, Priority and QoS parameters.

Example 16 is directed to the MA USB Hub of any preceding example, wherein the QoS parameters quantifies the end-to-end QoS parameters that the packets belonging to the identified Endpoint encounters.

Example 17 is directed to the MA USB Hub of any preceding example, wherein the processing logic further comprises dynamically updating the prioritization parameter when a subsequent Update Endpoint Quality-of-Service (QoS) Request frame is received.

Example 18 is directed to the MA USB Hub of any preceding example, wherein the Update Endpoint QoS Request is received from an MA USB Host.

Example 19 is directed to the MA USB Hub of any preceding example, wherein the Update Endpoint Quality-of-Service (QoS) Request frame comprises a payload identifying: transfer type, priority level, negative priority, Endpoint Channel Delay, Requested Bandwidth, Bandwidth Averaging Window and EP Handle List.

Example 20 is directed to the MA USB Hub of any preceding example, wherein the MA USB Hub further comprises an MA USB device.

Example 21 is directed to a non-transitory machine-readable medium comprising instructions executable on a processor circuitry to cause a Medium Agnostic Universal Serial Bus (MA USB) Host to provide prioritized data transmission to one of plurality of Endpoints within in an MA USB device, the instructions causing the processor circuitry to: determine one or more QoS parameters to be communicated to an identified Endpoint; execute a two-way handshake with the MA USB device to communicate the one or more QoS Parameters, wherein the two-way handshake further comprises: transmitting an Update Endpoint Quality-of-Service (QoS) Request frame to the first Endpoint at the MA USB Device; and receiving an Update Endpoint QoS Response from the MA USB Device.

Example 22 is directed to the medium of any preceding example, wherein the Update Endpoint QoS Request further comprises a data frame having one or more of transfer type, Endpoint Handle list, Priority and QoS parameters.

Example 23 is directed to the medium of any preceding example, wherein the QoS parameters quantifies the end-to-end QoS parameters that the packets belonging to the identified Endpoint encounters.

Example 24 is directed to the medium of any preceding example, wherein the processing logic further comprises dynamically updating the prioritization parameter by sending a subsequent Update Endpoint Quality-of-Service (QoS) Request frame to the first Endpoint at the MA USB Device.

Example 25 is directed to the medium of any preceding example, wherein the Update Endpoint QoS Response is received from an MA USB Hub or a MA USB portable device configured to execute the two-way handshake.

Example 26 is directed to the medium of any preceding example, wherein the Update Endpoint Quality-of-Service (QoS) Request frame comprises a payload identifying: transfer type, priority level, negative priority, Endpoint Channel Delay, Requested Bandwidth, Bandwidth Averaging Window and EP Handle List.

Example 27 is directed to a device to communicate one or more Quality-of-Service (QoS) parameters between a Medium Agnostic Universal Serial Bus (MA USB) Host and an MA USB device having one or more Endpoints, comprising: means for determining one or more parameters to be communicated to an identified Endpoint; means for executing a two-way handshake with the MA USB device to communicate the one or more QoS Parameters, wherein the means or executing two-way handshake further comprises: means for transmitting an Update Endpoint Quality-of-Service (QoS) Request frame to the first Endpoint at the MA USB Device; and means for receiving an Update Endpoint QoS Response from the MA USB Device.

Example 28 is directed to the device of any preceding example, wherein the Update Endpoint QoS Request further comprises a data frame having one or more of transfer type, Endpoint Handle list, Priority and QoS parameters.

Example 29 is directed to the device of any preceding example, wherein the QoS parameters quantifies the end-to-end QoS parameters that the packets belonging to the identified Endpoint encounters.

Example 30 is directed to the device of any preceding example, further comprising, dynamically updating the prioritization parameter by sending a subsequent Update Endpoint Quality-of-Service (QoS) Request frame to the first Endpoint at the MA USB Device.

Example 31 is directed to the device of any preceding example, wherein the device further comprises an MA USB Hub or a MA USB portable device configurable to execute the two-way handshake.

Example 32 is directed to the device of any preceding example, wherein the Update Endpoint Quality-of-Service (QoS) Request frame comprises a payload identifying: transfer type, priority level, negative priority, Endpoint Channel Delay, Requested Bandwidth, Bandwidth Averaging Window and EP Handle List.

Example 33 is directed to a machine-readable medium including code, when executed, to cause a machine to perform the method of any one of examples 27-32.

While the principles of the disclosure have been illustrated in relation to the exemplary embodiments shown herein, the principles of the disclosure are not limited thereto and include any modification, variation or permutation thereof.

What is claimed is:

1. A method to communicate one or more Quality-of-Service (QoS) parameters between a Medium Agnostic Universal Serial Bus (MA USB) Host and an MA USB device having one or more Endpoints, the method comprising:
determining one or more parameters to be communicated to an identified Endpoint;
executing a two-way handshake with the MA USB device to communicate the one or more QoS Parameters, wherein the two-way handshake further comprises:
transmitting an Update Endpoint Quality-of-Service (QoS) Request frame to the first Endpoint at the MA USB Device; and
receiving an Update Endpoint QoS Response from the MA USB Device.

2. The method of claim 1, wherein the Update Endpoint QoS Request further comprises a data frame having one or more of transfer type, Endpoint Handle list, Priority and QoS parameters.

3. The method of claim 2, wherein the QoS parameters quantifies the end-to-end QoS parameters that the packets belonging to the identified Endpoint encounters.

4. The method of claim 1, further comprising, dynamically updating the prioritization parameter by sending a subsequent Update Endpoint Quality-of-Service (QoS) Request frame to the first Endpoint at the MA USB Device.

5. The method of claim 1, wherein the device further comprises an MA USB Hub or a MA USB portable device configurable to execute the two-way handshake.

6. The method of claim 1, wherein the Update Endpoint Quality-of-Service (QoS) Request frame comprises a payload identifying: transfer type, priority level, negative priority, Endpoint Channel Delay, Requested Bandwidth, Bandwidth Averaging Window and EP Handle List.

7. A Medium Agnostic Universal Serial Bus (MA USB) Host comprising a Physical Adaptation Layer (PAL) and a Media-Access Control (MAC) Layer to provide prioritized data transmission to a one of plurality of Endpoints within in an MA USB device, wherein the HUB includes processing logic executable on a the PAL or the MAC layer to:
determine one or more QoS parameters to be communicated to an identified Endpoint;
execute a two-way handshake with the MA USB device to communicate the one or more QoS Parameters, wherein the two-way handshake further comprises:
transmitting an Update Endpoint Quality-of-Service (QoS) Request frame to the first Endpoint at the MA USB Device; and
receiving an Update Endpoint QoS Response from the MA USB Device.

8. The MA USB Host of claim 7, wherein the Update Endpoint QoS Request further comprises a data frame having one or more of transfer type, Endpoint Handle list, Priority and QoS parameters.

9. The MA USB Host of claim 8, wherein the QoS parameters quantifies the end-to-end QoS parameters that the packets belonging to the identified Endpoint encounters.

10. The MA USB Host of claim 7, wherein the processing logic further comprises dynamically updating the prioritization parameter by sending a subsequent Update Endpoint Quality-of-Service (QoS) Request frame to the first Endpoint at the MA USB Device.

11. The MA USB Host of claim 7, wherein the Update Endpoint QoS Response is received from an MA USB Hub or a MA USB portable device configured to execute the two-way handshake.

12. The MA USB Host of claim 7, wherein the Update Endpoint Quality-of-Service (QoS) Request frame comprises a payload identifying: transfer type, priority level, negative priority, Endpoint Channel Delay, Requested Bandwidth, Bandwidth Averaging Window and EP Handle List.

13. A Medium Agnostic Universal Serial Bus (MA USB) Hub comprising a Physical Adaptation Layer (PAL) and a Media-Access Control (MAC) Layer to receive data transmission to one of plurality of Endpoints associated therewith, wherein the Hub includes processing logic executable on the PAL or the MAC layer to:
receive an Update Endpoint Quality-of-Service (QoS) Request frame from an MA USB Host, wherein the Update Endpoint Quality-of-Service (QoS) Request frame is directed to an identified Endpoint associated with the MA USB Hub; and
transmit an Update Endpoint QoS Response to the MA USB Hub.

14. The MA USB Hub of claim 13, wherein the processing logic includes verifying the Update Endpoint Quality-of-Service (QoS) Request frame before transmitting an Update Endpoint QoS Response to the MA USB Hub.

15. The MA USB Hub of claim 13, wherein the Update Endpoint QoS Request further comprises a data frame having one or more of transfer type, Endpoint Handle list, Priority and QoS parameters.

16. The MA USB Hub of claim 15, wherein the QoS parameters quantifies the end-to-end QoS parameters that the packets belonging to the identified Endpoint encounters.

17. The MA USB Hub of claim 13, wherein the processing logic further comprises dynamically updating the prioritization parameter when a subsequent Update Endpoint Quality-of-Service (QoS) Request frame is received.

18. The MA USB Hub of claim 13, wherein the Update Endpoint QoS Request is received from an MA USB Host.

19. The MA USB Hub of claim 13, wherein the Update Endpoint Quality-of-Service (QoS) Request frame comprises a payload identifying: transfer type, priority level, negative priority, Endpoint Channel Delay, Requested Bandwidth, Bandwidth Averaging Window and EP Handle List.

20. The MA USB Hub of claim 13, wherein the MA USB Hub further comprises an MA USB device.

21. A non-transitory machine-readable medium comprising instructions executable on a processor circuitry to cause a Medium Agnostic Universal Serial Bus (MA USB) Host to provide prioritized data transmission to one of plurality of Endpoints within in an MA USB device, the instructions causing the processor circuitry to:
determine one or more QoS parameters to be communicated to an identified Endpoint;
execute a two-way handshake with the MA USB device to communicate the one or more QoS Parameters, wherein the two-way handshake further comprises:
transmitting an Update Endpoint Quality-of-Service (QoS) Request frame to the first Endpoint at the MA USB Device; and
receiving an Update Endpoint QoS Response from the MA USB Device.

22. The medium of claim 21, wherein the Update Endpoint QoS Request further comprises a data frame having one or more of transfer type, Endpoint Handle list, Priority and QoS parameters.

23. The medium of claim 22, wherein the QoS parameters quantifies the end-to-end QoS parameters that the packets belonging to the identified Endpoint encounters.

24. The medium of claim 21, wherein the processing logic further comprises dynamically updating the prioritization parameter by sending a subsequent Update Endpoint Quality-of-Service (QoS) Request frame to the first Endpoint at the MA USB Device.

25. The medium of claim 21, wherein the Update Endpoint QoS Response is received from an MA USB Hub or a MA USB portable device configured to execute the two-way handshake.

26. The medium of claim 21, wherein the Update Endpoint Quality-of-Service (QoS) Request frame comprises a payload identifying: transfer type, priority level, negative priority, Endpoint Channel Delay, Requested Bandwidth, Bandwidth Averaging Window and EP Handle List.
